(19) United States
(12) Patent Application Publication
(10) Pub. No.: US 2026/0103918 A1
(43) Pub. Date: Apr. 16, 2026

(54) JOINTED BAR LOCK

(71) Applicant: ABUS August Bremicker Söhne KG, Wetter-Volmarstein (DE)

(72) Inventor: Martin Hommel, Rehe (DE)

(21) Appl. No.: 19/355,065

(22) Filed: Oct. 10, 2025

(30) Foreign Application Priority Data
Oct. 14, 2024 (DE) 10 2024 129 694.1

(51) Int. Cl. E05B 67/00; E05B 15/16; E05B 67/04

(52) U.S. Cl. CPC E05B 67/003; E05B 15/1614; E05B 67/04; E05B 2015/1664

(57) ABSTRACT

The present invention relates to a jointed bar lock, in particular for a two-wheeler, comprising a lock body and a jointed bar arrangement that has a plurality of jointed bars connected to one another in an articulated manner, wherein the lock body and/or the jointed bars is/are at least regionally provided with a hard coating in each case.

### FIELD

The invention relates to a jointed bar lock, in particular for a two-wheeler, comprising a lock body and a jointed bar arrangement that has a plurality of jointed bars connected to one another in an articulated manner.

### BACKGROUND

Such a jointed bar lock, sometimes also referred to as a folding lock, is generally known. It can be folded together in a compact manner and already has a high security against being broken open due to the rigid jointed bars. A further improvement in the security against being broken could, for example, be achieved by a configuration of the jointed bars with a larger cross-section. However, this would inevitably result in a larger design and an increased weight of the jointed bar lock, which is in particular undesirable for mobile applications, for example, if the jointed bar lock is configured as a two-wheeler jointed bar lock that should be easy to take along.

### SUMMARY

It is an object of the invention to provide a jointed bar lock that has an increased security against being broken open with as low a weight as possible at the same time.

The object is satisfied by a jointed bar lock having the features of the present disclosure. Advantageous embodiments of the invention result from the entirety of the present disclosure, from the present description, and from the Figures.

The jointed bar lock according to the invention comprises a lock body and a jointed bar arrangement that has a plurality of jointed bars connected to one another in an articulated manner, wherein the lock body and/or the jointed bars is/are at least regionally provided with a hard coating in each case.

The hard coating helps to better ward off attacks on the jointed bar lock, in particular those attacks that are carried out with a cutting tool, such as an angle grinder. More precisely, the hard coating ensures that the time required to cut through a jointed bar or to cut open the lock body by means of an angle grinder is significantly increased, which in many cases makes a break-open attempt unattractive from the outset or at least prolongs it to such an extent that the risk of being caught during a break-open attempt is considerably increased. At the same time, the hard coating only adds slightly to the weight of the jointed bar lock so that, overall, a significantly higher level of security against being broken with an almost constant weight is achieved. The hard coating further proves to be advantageous in that the use of a thinner protective coating to protect the surface of an object to be secured by the jointed bar lock, e.g. a two-wheeler, against damage, in particular scratches, can be thinner than, for example, in the case of a welded-on armoring.

The hard coating can cover the entire outer surface of the jointed bar lock. For an effective protection, however, it is generally sufficient if the hard coating is only regionally applied, in particular in those surface regions of the jointed bar lock which would be preferentially attacked in the event of an attack by a cutting tool.

The jointed bar lock can in particular be configured as a jointed bar lock for a two-wheeler. A two-wheeler within the meaning of the invention can be a muscle-powered two-wheeler, an electric two-wheeler and/or a two-wheeler comprising an internal combustion drive. It is understood that the use of the jointed bar lock according to the invention is, however, not limited to two-wheeled vehicles.

According to one embodiment, the lock body comprises a lock housing which is formed from a hardened metal or a hardened metal alloy and to which the hard coating is applied. The hardened metal or the hardened alloy can be a material that has both a high chemical resistance, in particular a corrosion resistance, and a high mechanical load capacity. The material can in particular be hardened steel.

According to a further embodiment, the lock body comprises at least one additional reinforcing element which is in particular formed from a hardened metal or a hardened metal alloy and to which the hard coating is applied. The combination of an additional reinforcing element and the hard coating formed thereon increases the security against being broken open even further.

According to a further embodiment, each jointed bar comprises a core which is formed from a hardened metal or a hardened metal alloy and to which the hard coating is applied. This hardened metal or this hardened metal alloy can be the same material that is also used in the lock housing, e.g. hardened steel. In principle, however, different materials are also conceivable.

According to a further embodiment, the hard coating is applied to the entire outer surface of the jointed bar arrangement, in particular including the articulated points between adjacent jointed bars.

In this respect, the end sections of the jointed bar arrangement that are provided for the coupling to the lock body can remain free of the hard coating. These end sections serve to couple the jointed bar arrangement to the lock body and, in the closed state of the jointed bar lock, are received in the lock body and are thus not accessible from the outside. It is understood that the area of the uncoated end sections is kept to a minimum for an optimal protective effect, ideally such that no gaps remain in the hard coating that could be used for an attack.

In principle, it is sufficient for an optimal compromise between the cost-effectiveness in the manufacture of the jointed bar lock and the security against being broken open if the hard coating is only provided in regions of the lock housing and/or of the jointed bars that are accessible from the outside. An inner surface of the lock housing does not necessarily need to be additionally provided with a hard coating. In principle, it is, however, by all means conceivable to provide both an outer surface and an inner surface of the lock housing with a hard coating. A variant is further conceivable in which only an inner surface of the lock housing is provided with a hard coating.

According to a further embodiment, the hard coating is provided in at least one thickness-reduced central region of a jointed bar that in particular extends along a longitudinal direction of the jointed bar. If the arrangement of the hard coating is limited to the thickness-reduced central region, the security against being broken open can be increased without simultaneously also increasing the maximum outer dimensions of the jointed bar. In this way, a compact design of the jointed bar lock can be maintained despite the increased security against being broken open. According to one embodiment, a thickness-reduced central region, i.e. a depression, can in each case be formed on oppositely disposed surfaces, e.g. an upper side and an underside, of a jointed bar and can be provided with a hard coating.

According to a further embodiment, the hard coating is not provided in end sections of the jointed bars, in particular not in regions of the jointed bars in which a disk-shaped or ring-shaped spacer, which is in each case provided between two adjacent jointed bars, is arranged. This contributes to an ease of movement of the articulated joints and thus to a good handling of the jointed bar lock as a whole, in particular if the hard coating has a certain roughness. It is understood that the area of the uncoated end sections is also kept to a minimum here for an optimal protective effect, ideally such that no gaps remain in the hard coating that could be used for an attack. So that an optimal protective effect is also provided in the region of the jointed bars, for example, joining elements that connect adjacent jointed bars to one another, in the case of rivets in particular the rivet heads, can be provided with the hard coating.

For an even better security against being broken open, a disk-shaped or ring-shaped spacer, which is in particular formed from a hardened metal or a hardened metal alloy and which is in each case arranged between two adjacent jointed bars, can have a lateral surface that is at least regionally provided with a hard coating.

According to one embodiment, the hard coating comprises a plurality of grains of at least one hard material that is selected from a group comprising diamond, in particular synthetic diamond, diamond-like carbon, diamond-like carbon layers (DLC—Diamond-Like Carbon), a carbon modification with crystalline and amorphous regions, lonsdaleite, metal carbides, boron carbide (B₄C), tantalum carbide (TaC), titanium carbide (TiC), vanadium carbide (VC), in particular tungsten carbide (WC), silicon carbide (SiC), metal oxides, zirconium dioxide (ZrO₂), in particular aluminum oxide, particularly preferably aluminum oxide in the modification corundum, metal nitrides, titanium nitride (TiN), titanium aluminum nitride (TiAlN), chromium carbonitride (CrCN), silicon nitride (Si₃N₄) and/or boron nitride, in particular cubic boron nitride.

The hard material grains can in this respect be embedded in a metal-containing matrix. Said matrix can include a metal selected from a group comprising nickel, iron, cobalt, chromium, tantalum, titanium, manganese, zirconium, zinc, molybdenum, tungsten, aluminum and silicon. Furthermore, the hard material grains can be embedded in a matrix that is present as an alloy and/or an intermetallic phase. If the matrix comprises an alloy and/or intermetallic phases, the components can be selected from a group comprising nickel, iron, cobalt, chromium, titanium, tantalum, manganese, zirconium, zinc, molybdenum, tungsten, aluminum, boron, silicon, carbon and magnesium.

The hard material grains can have a grain size of 20 mesh to 80 mesh (0.841 mm to 0.177 mm).

The hard coating can be applied to the lock housing and/or the jointed bars by means of sintering, soldering, in particular brazing, welding, in particular laser welding, powder metallurgy, 3D printing, chemical or physical vapor deposition, or a galvanic process.

To protect the hard coating from, for example, corrosion and/or for a better adhesion of the hard coating to the base component, an electroplated coating can furthermore be applied to the hard coating. The electroplated coating can be formed from a cohesive structure of crystallites of a metal, a metal alloy or an intermetallic phase whose components are in particular selected from a group comprising nickel, iron, cobalt, chromium, titanium, tantalum, manganese, zirconium, zinc, molybdenum, tungsten, aluminum, boron, silicon, carbon and magnesium.

According to one embodiment, the hard coating is formed in one layer. Alternatively or additionally, the hard coating can at least regionally be formed in multiple layers. In this respect, at least two layers of a multilayer hard coating can have different properties.

A first property can comprise the material from which the hard material grains are formed. A second property can comprise the chemical composition of the matrix in which the hard material grains are embedded. A third property can relate to the grain size of the hard material grains that are embedded in the matrix.

If hard material grains of the same grain size are referred to in the following, this means that the grain size of hard material grains is uniform within the framework of a commercially available particle size distribution. Hard material grains of a uniform grain size can be used within one layer of the hard coating.

Alternatively, hard material grains of at least two different grain sizes can be used within one layer of the hard coating so that grains of a smaller size occupy the free spaces between larger grains. Grains of different grain sizes can be arranged in a plurality of layers of the hard coating. For example, the grain size can increase from a bottommost layer through one or more middle layers up to an uppermost layer. Alternatively, the grain size can decrease from a bottommost layer through one or more middle layers up to an uppermost layer. Furthermore, the grain sizes can vary in different layers and can have large and small particles in an alternating manner, starting from a bottommost layer, through one or more middle layers up to an uppermost layer. Furthermore, a gradient of increasing or decreasing grain sizes can be present within one layer.

A fourth property can relate to the mean distance at which a respective two adjacent hard material grains are arranged from one another. The distance between two adjacent hard material grains is defined as the shortest possible straight line between a surface point of the one hard material grain and a surface point of the other hard material grain. The mean distance results from the arithmetic mean of the distance of at least 10 different hard material grains from their adjacent hard material grains. The mean distance between two adjacent hard material grains can be in the range from 0 to 1 mm, preferably in the range from 0 to 0.5 mm and particularly preferably in the range from 0 to 0.250 mm.

A fifth property can comprise the thickness of a layer of the hard coating. In this context, the thickness of a layer is defined as the averaged thickness of the matrix forming it. The thickness of a layer can be in a range from 10 μm to 1 mm, preferably in a range from 50 μm to 800 μm and particularly preferably in a range from 75 μm to 500 μm. The grain size of the hard material grains can be smaller than the layer thickness of the matrix surrounding it. However, it is also possible that the grain size of at least some of the hard material grains present in the layer is larger than the layer thickness of the matrix surrounding it.

A sixth property can relate to a structure with which a layer of the hard coating is applied. For example, a layer of the hard coating does not need to cover a continuous surface, but it can rather be formed in the form of mutually spaced apart lines or stripes or mutually spaced apart polygons, such as triangles, squares, pentagons or hexagons.

According to one embodiment, the hard coating can be applied to the lock housing and/or the jointed bars by means of sintering, soldering, in particular brazing, welding, in particular laser welding, powder metallurgy, 3D printing, chemical or physical vapor deposition, or a galvanic process.

According to yet a further embodiment, the lock body and/or the jointed bars can additionally be provided with a protective coating that is composed of a polymer, for example, an elastomer and in particular rubber and that protects the surface of an object to be secured by the jointed bar lock, e.g. a two-wheeler, against damage, in particular scratches. The protective coating can have a maximum thickness of 3 mm and/or can be formed with different thicknesses in different regions of the jointed bar lock. For example, the thickness of the protective coating on the flat sides of a jointed bar cannot exceed 1 mm, whereas it can amount to up to 2 mm at the narrow sides of a jointed bar.

### BRIEF DESCRIPTION OF THE DRAWINGS

The invention will be explained in the following purely by way of example with reference to possible embodiments and to the enclosed drawing.

FIG. 1 is a perspective view of a jointed bar lock with a jointed bar arrangement;

FIG. 2 is a perspective view of the jointed bar arrangement of FIG. 1;

FIG. 3 is an exploded view of two jointed bars of the jointed bar arrangement of FIGS. 1 and 2 and of articulated components connecting them;

FIG. 4 is a cross-sectional view of a jointed bar of FIG. 3 with a single-layer hard coating;

FIG. 5 is an enlarged cross-sectional view of the single-layer hard coating of FIG. 4;

FIG. 6 is a cross-sectional view of a two-layer hard coating; and

FIG. 7 is a cross-sectional view of a two-layer hard coating with an additional electroplated coating.

### DETAILED DESCRIPTION

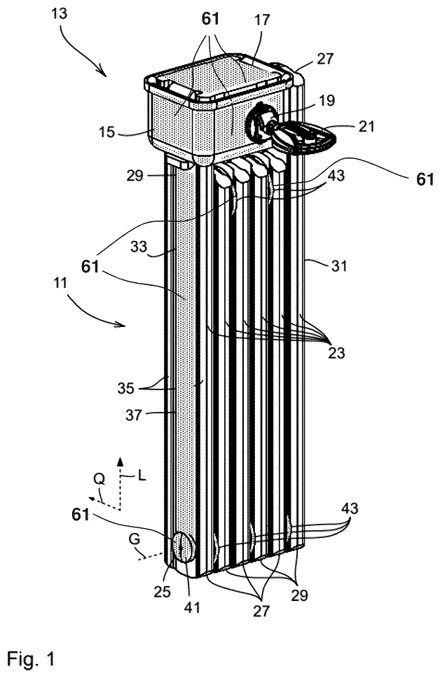

In FIG. 1, a jointed bar lock 13 according to the invention comprising a jointed bar arrangement 11 and a lock body 15 is shown. The lock body 15 comprises a lock housing 17 and a locking mechanism 19 that is accommodated therein and that enables an unlocking and a locking of the jointed bar lock 13 by means of a key 21.

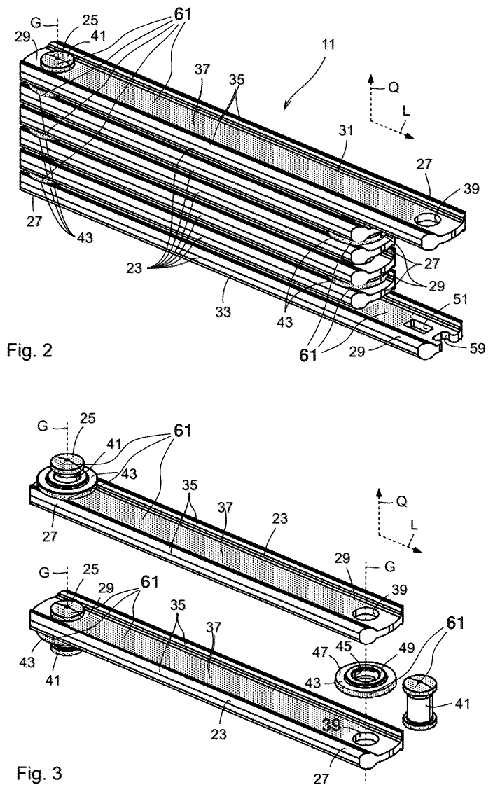

FIG. 2 shows the jointed bar arrangement 11 without the lock body 15. The jointed bar arrangement 11 comprises a plurality of jointed bars 23 connected in an articulated manner to one another by means of articulated joints 25, each of said jointed bars extending along a longitudinal extent L from a first end section 27 to a second end section 29. Specifically, the jointed bar arrangement 11 comprises a first jointed bar 31, a last jointed bar 33 and four jointed bars 23 connected in series therebetween. The first jointed bar 31 is permanently anchored in the lock body 15 via its first end section 27. At its second end section 29, the last jointed bar 33 has a latch recess 59, which enables a latching into the lock body 15, and a locking recess 51 into which a latch of the locking mechanism 19 can engage for a locking of the jointed bar lock 13.

Each jointed bar has reinforced longitudinal margins 35 that extend continuously over the entire longitudinal extent L of the jointed bar and thus define a thickness-reduced central region 37 on an upper side and an underside of the jointed bar.

FIG. 3 shows the structure of an articulated joint 25 between two adjacent jointed bars 23. Specifically, the articulated joint 25 serves to connect the first end section 27 of the one jointed bar 23 to the second end section 29 of the other jointed bar 23. The articulated joint 25 comprises a rivet element 41 that is guided through openings, which are arranged above one another concentrically to a joint axis G and which contain a first opening 39 of the one jointed bar 23, an opening 45 of a disk element 43 and a second opening 39 of the other jointed bar 23, and in this way produces a pivotable connection between the jointed bars 23. The disk element 43 seated between the jointed bars 23 has, adjacent to its opening 45 and extending radially outwardly, first a bead section 49 that is thickened at both sides and, adjacent thereto, a thickness-reduced flat section 47. The bead section 49, both in its diameter and in its overall thickness viewed over both sides, fits into the free space formed by the thickness-reduced central regions 37 of the jointed bars. The oppositely disposed planar surfaces of the flat section 47 rest on the thickened longitudinal margins 35 of the jointed bars 23. The rivet element 41 has a cylindrical basic shape whose ends are configured as rivet buttons and have an extended diameter with respect to the middle part of the rivet element.

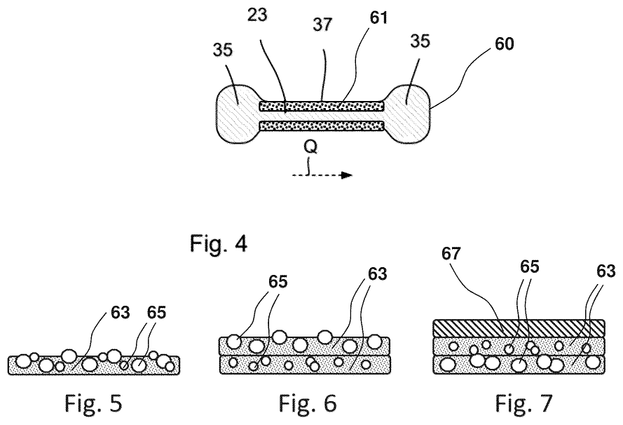

FIG. 4 shows a jointed bar 23 in cross-section. As already mentioned, the reinforced longitudinal margins 35 extend at both sides beyond the height of the thickness-reduced central region 37 so that a core 60 of the jointed bar 23, in this embodiment example over substantially its entire length of the jointed bar 23, has an H-shaped or bone-shaped cross-section.

Furthermore, a hard coating 61 is applied to the jointed bars 23 in a materially bonded manner, for example, by means of sintering, soldering, in particular brazing, welding, in particular laser welding, powder metallurgy, 3D printing, chemical or physical vapor deposition, or a galvanic process.

In the embodiment example shown, the hard coating 61 is only provided on the surfaces of the thickness-reduced central regions 37 of each jointed bar 23. Alternatively, the hard coating 61 can also completely cover the jointed bars 23, viewed in cross-section, and can thus be provided not only in the thickness-reduced central regions 37, but also on the reinforced longitudinal margins 35.

The hard coating 61 extends over almost the entire length of the jointed bar 23; only the end sections 27, 29 are without a hard coating 61 (FIGS. 2 and 3). The outer surface of the lock housing 17 is also provided with such a hard coating 61 (FIG. 1), as are the heads of the rivet elements 41 and the radially outer surfaces of the disk elements 43.

The hard coating 61 comprises a plurality of grains 65, embedded in a metal-containing matrix 63, of one or more hard materials that are selected from a group comprising diamond, in particular synthetic diamond, diamond-like carbon, diamond-like carbon layers (DLC—Diamond-Like Carbon), a carbon modification with crystalline and amorphous regions, lonsdaleite, metal carbides, boron carbide (B₄C), tantalum carbide (TaC), titanium carbide (TiC), vanadium carbide (VC), in particular tungsten carbide (WC), silicon carbide (SiC), metal oxides, zirconium dioxide (ZrO₂), in particular aluminum oxide, particularly preferably aluminum oxide in the modification corundum, metal nitrides, titanium nitride (TiN), titanium aluminum nitride (TiAlN), chromium carbonitride (CrCN), silicon nitride (Si₃N₄) and/or boron nitride, in particular cubic boron nitride. The hard material grains 65 can, for example, have a grain size of 20 mesh to 80 mesh (0.841 mm to 0.177 mm).

The matrix 63 itself can have a metal selected from a group comprising nickel, iron, cobalt, chromium, tantalum, titanium, manganese, zirconium, zinc, molybdenum, tungsten, aluminum, and silicon. Furthermore, the matrix 63 can be present as an alloy and/or an intermetallic phase. If the matrix comprises an alloy and/or intermetallic phases, the components can be selected from a group comprising nickel, iron, cobalt, chromium, titanium, tantalum, manganese, zirconium, zinc, molybdenum, tungsten, aluminum, boron, silicon, carbon and magnesium.

The hard coating 61 used in the jointed bar lock 13 described above can be formed in one or more layers. For example, the hard coating 61 can be formed by a layer of a matrix 63 in which only one type of hard material grains 65 is embedded, i.e. hard material grains 65 of the same material and at least substantially the same size.

In contrast, a single-layer hard coating 61 is shown in FIG. 5 that has a mixture of hard material grains 65 of different sizes. In this respect, a first quantity of hard material grains 65 is completely embedded in the matrix 63, while a second quantity of hard material grains 65 is only partly embedded in the matrix 63 of the hard coating and partly protrudes from the matrix 63, whereby the hard coating 61 has a certain surface roughness.

Furthermore, a two-layer hard coating 61 is shown in FIG. 6 that comprises a lower layer of a first matrix 63 in which hard material grains 65 of a smaller size are arranged that are completely enclosed by the first matrix 63. In addition, the hard coating 61 comprises an upper layer of a second matrix 63 in which hard material grains 65 of a larger size are arranged, some of which are completely enclosed by the second matrix 63 and some of which protrude from the matrix 63.

In contrast, a two-layer hard coating 61 is shown in FIG. 7 that comprises a lower layer of a first matrix 63, in which hard material grains 65 of a larger size are arranged, and an upper layer of a second matrix 63 in which hard material grains 65 of a smaller size are arranged.

In addition, the upper layer of the hard coating 61 is covered with an electroplated coating 67 that is formed by a structure of connected crystallites of metal or a metal alloy that has been subjected to a hardening and that forms a corrosion protection for the underlying material.

Finally, the jointed bar lock 13 can be at least regionally covered by a protective coating, not shown, composed of a polymer, for example an elastomer and in particular rubber, in order to protect an object to be secured by the jointed bar lock 13, e.g. a two-wheeler, against surface damage, in particular scratches.

### REFERENCE NUMERAL LIST

11 jointed bar arrangement
13 jointed bar lock
15 lock body
17 lock housing
19 locking mechanism
21 key
23 jointed bar
25 articulated joint
27 first end section
29 second end section
31 first jointed bar
33 last jointed bar
35 longitudinal margin
37 central region
41 rivet element
43 disk element
45 opening
47 flat section
49 bead section
51 locking recess
59 latch recess
60 core
61 hard coating
63 matrix
65 hard material grain
67 electroplated coating
L longitudinal extent
Q transverse extent
G joint axis

What is claimed is:

1. A jointed bar lock the jointed bar lock comprising a lock body and a jointed bar arrangement that has a plurality of jointed bars connected to one another in an articulated manner, wherein the lock body and/or the jointed bars is/are at least regionally provided with a hard coating in each case.

2. The jointed bar lock according to claim 1 that is configured for a two wheeler.

3. The jointed bar lock according to claim 1,
wherein the lock body comprises a lock housing which is formed from a hardened metal or a hardened metal alloy and to which the hard coating is applied.

4. The jointed bar lock according to claim 1,
wherein the lock body comprises at least one additional reinforcing element.

5. The jointed bar lock according to claim 4,
wherein the at least one additional reinforcing element is formed from a hardened metal or a hardened metal alloy and wherein the hard coating is applied to the at least one additional reinforcing element.

6. The jointed bar lock according to claim 1,
wherein each jointed bar comprises a core which is formed from a hardened metal or a hardened metal alloy and to which the hard coating is applied.

7. The jointed bar lock according to claim 1,
wherein the hard coating is applied to the entire outer surface of the jointed bar arrangement.

8. The jointed bar lock according to claim 1,
wherein the hard coating is only provided in regions of the lock housing and/or of the jointed bars that are accessible from the outside.

9. The jointed bar lock according to claim 1,
wherein the hard coating is provided in at least one thickness-reduced central region of a jointed bar that in particular extends along a longitudinal direction of the jointed bar.

10. The jointed bar lock according to claim 1,
wherein the hard coating is not provided in end sections of the jointed bars.

11. The jointed bar lock according to claim 10,
wherein the hard coating is not provided in regions of the jointed bars in which a disk-shaped or ring-shaped spacer, which is in each case provided between two adjacent jointed bars, is arranged and/or in regions of the jointed bars that engage into the lock body.

12. The jointed bar lock according to claim 1,
wherein a disk-shaped or ring-shaped spacer is in each case arranged between two adjacent jointed bars and has a lateral surface that is at least regionally provided with a hard coating.

13. The jointed bar lock according to claim 12,
wherein the disk-shaped or ring-shaped spacer is formed from a hardened metal or a hardened metal alloy.

14. The jointed bar lock according to claim 1,
wherein the hard coating is formed in one layer; and/or
wherein the hard coating is at least regionally formed in multiple layers; and/or
wherein at least two layers of a multilayer hard coating have different properties.

15. The jointed bar lock according to claim 1,
wherein the hard coating comprises a plurality of grains of at least one hard material that is selected from a group comprising diamond, synthetic diamond, diamond-like carbon, diamond-like carbon layers (DLC—Diamond-Like Carbon), a carbon modification with crystalline and amorphous regions, lonsdaleite, metal carbides, boron carbide (B₄C), tantalum carbide (TaC), titanium carbide (TiC), vanadium carbide (VC), tungsten carbide (WC), silicon carbide (SiC), metal oxides, zirconium dioxide (ZrO₂), aluminum oxide, aluminum oxide in the modification corundum, metal nitrides, titanium nitride (TiN), titanium aluminum nitride (TiAlN), chromium carbonitride (CrCN), silicon nitride (Si₃N₄), boron nitride and/or cubic boron nitride.

16. The jointed bar lock according to claim 15,
wherein the hard material grains are embedded in a metal-containing matrix.

17. The jointed bar lock according to claim 15,
wherein the hard material grains have a grain size of 20 mesh to 80 mesh(0.841 mm to 0.177 mm).

18. The jointed bar lock according to claim 1,
wherein the hard coating is applied to the lock housing and/or the jointed bars by means of sintering, soldering, brazing, welding, laser welding, powder metallurgy, 3D printing, chemical or physical vapor deposition, or a galvanic process.

19. The jointed bar lock according to claim 1,
wherein an electroplated coating is applied to the hard coating.

20. The jointed bar lock according to claim 1,
wherein the lock body and/or the jointed bars is/are additionally provided with a protective coating composed of a polymer.

21. The jointed bar lock according to claim 20,
wherein the protective coating is composed of an elastomer and/or rubber.
